(19) United States
(12) Patent Application Publication
(10) Pub. No.: US 2023/0404323 A1
(43) Pub. Date: Dec. 21, 2023

(54) HANDLE OF AIR FRYER AND AIR FRYER

(71) Applicant: Tsann Kuen (Zhangzhou) Enterprise Co., Ltd., Zhangzhou (CN)

(72) Inventors: Lin Wu, Zhangzhou (CN); Guowei Huang, Zhangzhou (CN)

(21) Appl. No.: 18/123,372

(22) Filed: Mar. 20, 2023

(30) Foreign Application Priority Data
Jun. 15, 2022 (CN) 202221496626.2

(51) Int. Cl. A47J 37/06; A47J 45/06

(52) U.S. Cl. CPC A47J 37/0664; A47J 37/0641; A47J 45/06

(57) ABSTRACT

A handle of an air fryer configured to be connected to a pot body of the air fryer comprises a handle body and a spraying device disposed on the handle body. The spraying device comprises a liquid storage reservoir, a spray head, and a pumping mechanism. The liquid storage reservoir is detachably disposed on the handle body, and a liquid spraying direction of the spray head faces an inside of the pot body. The pumping mechanism is connected to the spray head and the liquid storage reservoir to pump a liquid in the liquid storage reservoir to the spray head for spraying.

### RELATED APPLICATIONS

This application claims priority to Chinese patent application number 202221496626.2, filed on Jun. 15, 2022. Chinese patent application number 202221496626.2 is incorporated herein by reference.

### FIELD OF THE DISCLOSURE

The present disclosure relates to a handle of an air fryer and the air fryer.

### BACKGROUND OF THE DISCLOSURE

An air fryer is a common small household appliance in the market. The existing air fryer basically comprises a base device, an air inlet device disposed above the base device and configured for flowing of air into the air inlet device, a heating chamber disposed in the base device and the air inlet device and configured for receiving food, and a hot air device disposed in the heating chamber and configured for heating the food. When in use, the hot air device guides a hot air flow of the air inlet device into the heating chamber for rapidly heating the food to form a vortex heat flow that circulates rapidly to cook the food and dry surface moisture of the food, so that the cooked food has a look and taste of frying. However, the cooking method of the air fryer results in a water loss on a surface of the food being relatively large, and the food cannot be seasoned during a heating process.

### BRIEF SUMMARY OF THE DISCLOSURE

The present disclosure provides a handle of an air fryer and the air fryer to solve the deficiencies in the background.

In order to solve the technical problem, the present disclosure provides a handle of an air fryer. The handle is configured to be connected to a pot body of the air fryer. The handle comprises a handle body and a spraying device disposed on the handle body. The spraying device comprises a liquid storage reservoir, a spray head, and a pumping mechanism. The liquid storage reservoir is detachably disposed on the handle body, and a liquid spraying direction of the spray head faces an inside of the pot body. The pumping mechanism is connected to the spray head and the liquid storage reservoir to pump a liquid in the liquid storage reservoir to the spray head for spraying.

In a preferred embodiment, the pumping mechanism comprises a button for controlling liquid discharge, and the button is disposed on the handle body.

In a preferred embodiment, the spray head is a mist-spraying head.

In a preferred embodiment, the liquid spraying direction of the spray head extends obliquely from an edge of the pot body toward a middle portion of a bottom of the pot body.

In a preferred embodiment, the spraying device further comprises a connecting joint and a liquid inlet pipe which are disposed in the handle body, and the liquid storage reservoir comprises a liquid outlet located on a bottom of the liquid storage reservoir. The liquid outlet of the liquid storage reservoir is configured to be detachably and hermetically connected to the connecting joint. The liquid inlet pipe is connected to the connecting joint and the pumping mechanism so as to enable the liquid storage reservoir to be in communication with the pumping mechanism.

In a preferred embodiment, the connecting joint comprises a liquid inlet column extending upward for a certain distance, and the liquid outlet is disposed with a sealing sleeve configured for elastic deformation. The liquid inlet column is configured to be inserted into the sealing sleeve to achieve a hermetical connection.

In a preferred embodiment, the spraying device further comprises a liquid inlet pipe. When the liquid storage reservoir is connected to the handle body, the liquid inlet pipe is inserted into the liquid storage reservoir from top to bottom, and the liquid inlet pipe is connected to the pumping mechanism to enable the liquid storage reservoir to be in communication with the pumping mechanism.

In a preferred embodiment, the handle body comprises a first connecting portion, and an upper end of the liquid storage reservoir comprises a second connecting portion. When the liquid inlet pipe is inserted into the liquid storage reservoir from the top to the bottom, the second connecting portion is detachably connected to the first connecting portion.

In a preferred embodiment, the pumping mechanism comprises a pumping chamber, a piston rod, and an elastic member. The pumping chamber comprises a liquid inlet port and a liquid outlet port, and the liquid inlet port is disposed with a check valve. The elastic member abuts the piston rod and a chamber wall of the pumping chamber, and the liquid inlet port is connected to the liquid inlet pipe. The liquid outlet port is connected to the spray head, and a distal end of the piston rod extends out of the pumping chamber to define or be connected to a button for controlling liquid discharge. The button is configured to be controlled by an external force to drive the piston rod to pump the liquid in the pumping chamber to the spray head, and the elastic member is configured to drive the piston rod to move to an original position to suck the liquid in the liquid inlet pipe into the pumping chamber through the check valve.

The present disclosure further provides an air fryer comprising the handle.

Compared with the existing techniques, the technical solution has the following advantages: by setting the spraying device on the handle, spraying water or seasoning liquid on the food in the air fryer is enabled, so as to improve a taste of the food.

### BRIEF DESCRIPTION OF THE DRAWINGS

FIG. 1 illustrates a perspective view of an air fryer in Embodiment 1 of the present disclosure.

FIG. 2 illustrates a cross-sectional view of the air fryer in Embodiment 1 of the present disclosure.

FIG. 3 illustrates a cross-sectional view of a handle in Embodiment 1 of the present disclosure.

FIG. 4 illustrates a perspective view of an air fryer in Embodiment 2 of the present disclosure.

FIG. 5 illustrates a cross-sectional view of the air fryer in Embodiment 2 of the present disclosure.

FIG. 6 illustrates a cross-sectional view of an air fryer some other embodiments of the present disclosure.

### DETAILED DESCRIPTION OF THE EMBODIMENTS

The present disclosure will be further described below in combination with the accompanying drawings and embodiments.

### Embodiment 1

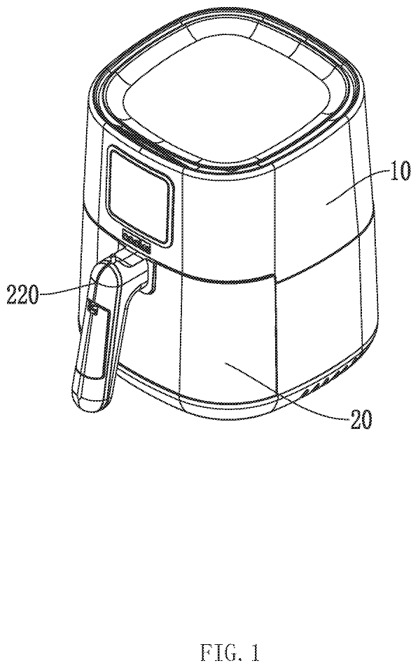

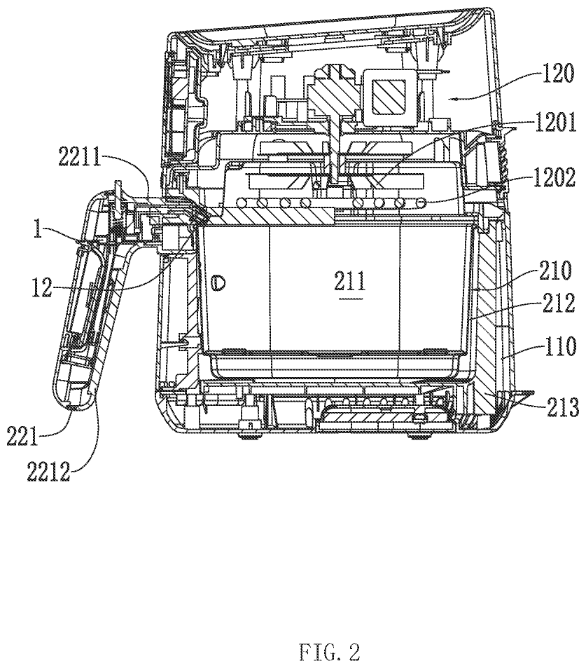

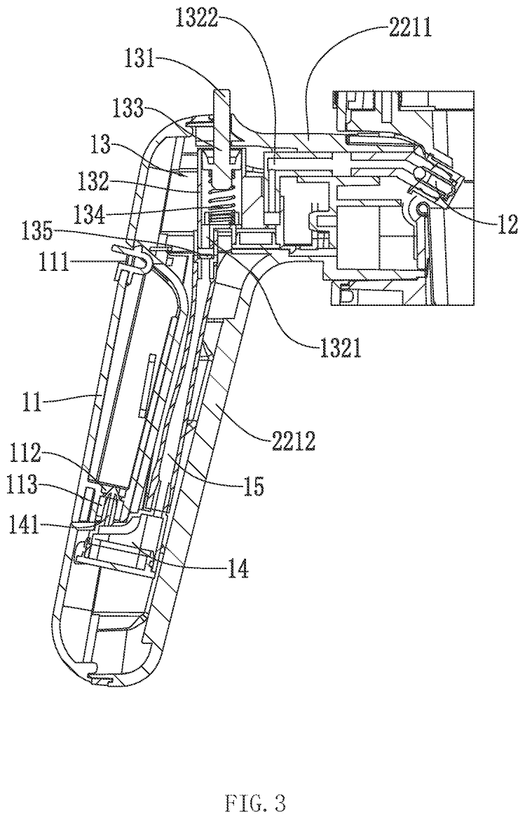

Referring to FIGS. 1 to 3, an air fryer is provided, and the air fryer comprises a body 10 and a pot 20. The body 10 comprises an accommodation space 110 located on a lower part of the body 10, and an upper part of the body 10 comprises a heating element 120. The heating element 120 is configured to supply hot air toward the accommodation space 110. The heating element 120 comprises a fan 1201 and a heater 1202, and the fan 1201 is configured for suction of air to pass through the heater 1202 to form the hot air. An air supply direction of the heating element 120 faces the accommodation space 110. The pot 20 comprises a pot body 210 and a handle 220 connected to the pot body 210. The pot body 210 comprises a cooking cavity 211 having an opening facing upward. The handle 220 comprises a handle body 221, and the handle body 221 comprises a connecting portion 2211 extending along a lateral direction of the handle body 221 and a handheld portion 2212 extending along a longitudinal direction of the handle body 221. The connecting portion 2211 is respectively connected to an upper end of the handheld portion 2212 and an upper end of the pot body 210, and a user can grasp the handheld portion 2212 to enable the pot 20 to be placed in or separated from the accommodation space 110. When the pot 20 is placed in the accommodation space 110, the air supply direction of the heating element 120 faces the cooking cavity 211.

The handle 220 further comprises a spraying device 1 disposed on the handle body 221. The spraying device 1 comprises a liquid storage reservoir 11, a spray head 12, and a pumping mechanism 13. The liquid storage reservoir 11 is detachably disposed on the handle body 221. A liquid spraying direction of the spray head 12 faces an inside of the pot body 210, and the pumping mechanism 13 is connected to the spray head 12 and the liquid storage reservoir 11 to pump a liquid in the liquid storage reservoir 11 to the spray head 12 for spraying. The liquid storage reservoir 11 can be detached from the handle body 221 to be filled with water or seasoning liquid (e.g., soy sauce, vinegar, etc.). During a cooking process of the air fryer, food is placed in the cooking cavity 211, the food is heated by the hot air generated by the heating element 120 and blown to the cooking cavity 211, and the user can control the pumping mechanism 13 to spray the water or the seasoning liquid onto the food to achieve a convenient and quick cooking process. In this embodiment, the pumping mechanism 13 comprises a button 131 for controlling liquid discharge. The button 131 is disposed on the handle body 221, and the user can control the button 131 conveniently.

Specifically, the pot body 210 comprises a metal cavity 212 defining the cooking cavity 211 and a holding container 213 for receiving the metal cavity 212, and the handle body 221 is detachably or fixedly connected to a front panel of the holding container 213. The user can grasp the handle body 221 to take the pot body 210 into and out of the accommodation space 110, and the front panel can be matched with an opening of the accommodation space 110.

In this embodiment, the spray head 12 abuts an upper edge of the metal cavity 212. The liquid spraying direction of the spray head 12 faces the inside of the pot body 210 from top to bottom. Specifically, the liquid spraying direction of the spray head 12 faces a bottom wall of the metal cavity 212, and the liquid spraying direction of the spray head 12 extends obliquely from an edge of the pot body 210 toward a middle portion of a bottom of the pot body 210, that is, from the upper edge of the metal cavity 212 toward a middle portion of the bottom wall of the metal cavity 212. The liquid spraying direction of the spray head 12 enables the food in the metal cavity 212 to be sprayed more completely. Furthermore, the spray head 12 is a mist-spraying head, and the spray head 12 can spray a wide range of liquid mist so that the food can be sprayed more completely to improve taste of the food or carry out seasoning.

In this embodiment, the liquid storage reservoir 11 is disposed on the handheld portion 2212. The pumping mechanism 13 is located on a junction of the handheld portion 2212 and the connecting portion 2211, and the button 131 is disposed on an upper side of the connecting portion 2211. A distal end of the connecting portion 2211 is configured for connection to the holding container 213, and the spray head 12 is located on a distal end surface of the connecting portion 2211 to face the metal cavity 212.

An outer side of the handheld portion 2212 comprises a receiving groove for receiving the liquid storage reservoir 11. When the liquid storage reservoir 11 is disposed in the receiving groove, an outer surface of the liquid storage reservoir 11 and an outer surface of the handheld portion 2212 are flush with each other. An opening of the liquid storage reservoir 11 faces upward, and an upper end of the liquid storage reservoir 11 comprises a buckle structure 111 configured to be buckled to the handheld portion 2212. The spraying device 1 further comprises a connecting joint 14 and a liquid inlet pipe 15, which are disposed in the handle body 221. The liquid storage reservoir 11 comprises a liquid outlet 112 located on a bottom of the liquid storage reservoir 11, and the liquid outlet 112 of the liquid storage reservoir 11 can be detachably and hermetically connected to the connecting joint 14. The liquid inlet pipe 15 is connected to the connecting joint 14 and the pumping mechanism 13 so as to enable the liquid storage reservoir 11 to be in communication with the pumping mechanism 13. The connecting joint 14 comprises a liquid inlet column 141 extending upward for a certain distance, and the liquid inlet column 141 extends into the receiving groove. The liquid outlet 112 is disposed with a sealing sleeve 113 configured for elastic deformation, and the liquid inlet column 141 can be inserted into the sealing sleeve 113 to achieve a hermetical connection. The sealing sleeve 113 is made of silicone. When the liquid inlet column 141 is inserted into the sealing sleeve 113, the sealing sleeve 113 is tightly sleeved on an outer wall of the liquid inlet column 141 to achieve sealing. A distal end of the liquid inlet column 141 is in communication with an inner space of the liquid storage reservoir 11.

The pumping mechanism 13 comprises a pumping chamber 132, a piston rod 133, and an elastic member 134. The pumping chamber 132 comprises a liquid inlet port 1321 and a liquid outlet port 1322, and the liquid inlet port 1321 is disposed with a check valve 135. The elastic member 134 abuts the piston rod 133 and a chamber wall of the pumping chamber 132. The liquid inlet port 1321 is connected to the liquid inlet pipe 15, and the liquid outlet port 1322 is connected to the spray head 12. A distal end of the piston rod 133 extends out of the pumping chamber 132 to define the button 131 for controlling the liquid discharge. The button 131 can be controlled by an external force to drive the piston rod 133 to pump the liquid in the pumping chamber 132 to the spray head 12. The elastic member 134 is configured to drive the piston rod 133 to move to an original position to suck the liquid in the liquid inlet pipe 15 into the pumping chamber 132 through the check valve 135. The check valve 135 is a conventional mechanical mechanism, which will not be further described herein. The elastic member 134 is a spring.

### Embodiment 2

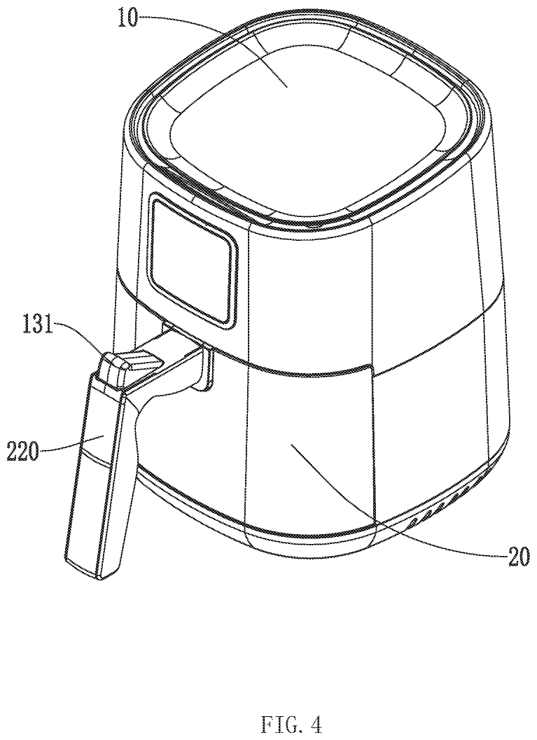

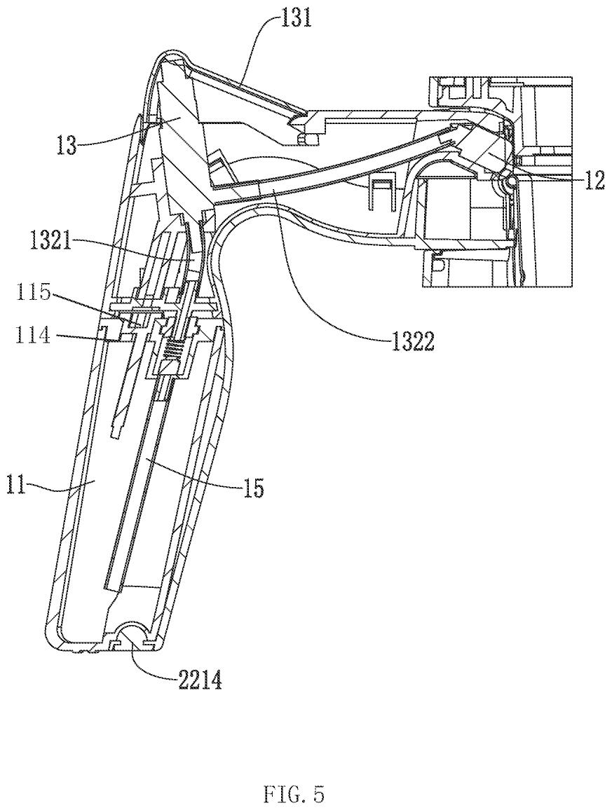

Referring to FIG. 4 and FIG. 5, the difference between this embodiment and the embodiment 1 lies in the arrangement of the liquid inlet pipe 15 of the spraying device 1. When the liquid storage reservoir 11 is connected to the handle body 221, the liquid inlet pipe 15 is inserted into the liquid storage reservoir 11 from top to bottom, and the liquid inlet pipe 15 is connected to the pumping mechanism 13 to enable the liquid storage reservoir 11 to be in communication with the pumping mechanism 13.

A lower side of the handheld portion 2212 comprises a receiving groove, and a bottom of the receiving groove comprises a positioning and fixing plug 2214. The liquid storage reservoir 11 is disposed in the receiving groove, and a bottom of the liquid storage reservoir 11 is positioned and connected to the positioning and fixing plug 2214. The upper end of the liquid storage reservoir 11 comprises a liquid replenishment port 114, and the liquid replenishment port 114 is detachably disposed with a sealing plug 115.

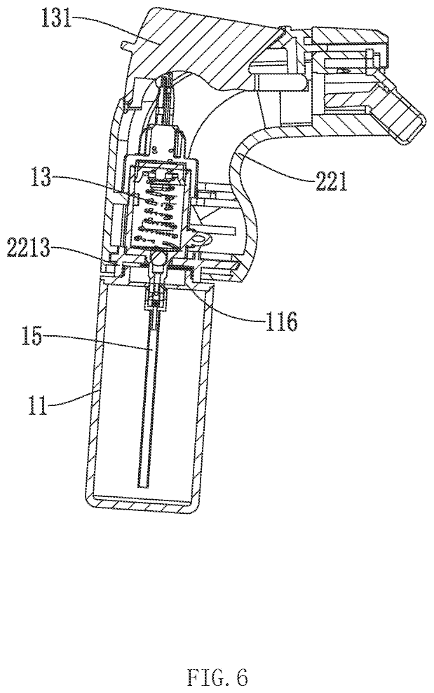

Referring to FIG. 6, in some other embodiments, the handle body 221 comprises a first connecting portion 2213, and the upper end of the liquid storage reservoir 11 comprises a second connecting portion 116. When the liquid inlet pipe 15 is inserted into the liquid storage reservoir 11 from top to bottom, the second connecting portion 116 is detachably connected to the first connecting portion 2213. The first connecting portion 2213 and the second connecting portion 116 may be internal and external threads or a snap structure.

The pumping mechanism 13 comprises the pumping chamber 132, the piston rod 133, and the elastic member 134. The pumping chamber 132 comprises the liquid inlet port 1321 and the liquid outlet port 1322, and the liquid inlet port 1321 is disposed with the check valve 135. The elastic member 134 abuts the piston rod 133 and the chamber wall of the pumping chamber 132. The liquid inlet port 1321 is connected to the liquid inlet pipe 15, and the liquid outlet port 1322 is connected to the spray head 12. A distal end of the piston rod 133 extends out of the pumping chamber 132 to define the button 131 for controlling the liquid discharge. The button 131 can be controlled by the external force to drive the piston rod 133 to pump the liquid in the pumping chamber to the spray head 12. The elastic member 134 is configured to drive the piston rod 133 to move to the original position to suck the liquid in the liquid inlet pipe 15 into the pumping chamber 132 through the check valve 135. The check valve 135 is a conventional mechanical mechanism, which will not be further described herein. The elastic member 134 is the spring.

When the spraying device 1 is in use, the user only needs to press the button 131 to achieve a function of spraying water mist or seasoning liquid, which is convenient and direct.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A handle of an air fryer configured to be connected to a pot body of the air fryer, comprising:
a handle body, and
a spraying device disposed on the handle body, wherein:
the spraying device comprises a liquid storage reservoir, a spray head, and a pumping mechanism,
the liquid storage reservoir is detachably disposed on the handle body,
a liquid spraying direction of the spray head faces an inside of the pot body, and
the pumping mechanism is connected to the spray head and the liquid storage reservoir to pump a liquid in the liquid storage reservoir to the spray head for spraying.

2. The handle of the air fryer configured to be connected to the pot body of the air fryer according to claim 1, wherein:
the pumping mechanism comprises a button for controlling liquid discharge, and
the button is disposed on the handle body.

3. The handle of the air fryer configured to be connected to the pot body of the air fryer according to claim 1, wherein:
the spray head is a mist-spraying head.

4. The handle of the air fryer configured to be connected to the pot body of the air fryer according to claim 1, wherein:
the liquid spraying direction of the spray head extends obliquely from an edge of the pot body toward a middle portion of a bottom of the pot body.

5. The handle of the air fryer configured to be connected to the pot body of the air fryer according to claim 1, wherein:
the spraying device further comprises a connecting joint and a liquid inlet pipe which are disposed in the handle body,
the liquid storage reservoir comprises a liquid outlet located on a bottom of the liquid storage reservoir,
the liquid outlet of the liquid storage reservoir is configured to be detachably and hermetically connected to the connecting joint, and
the liquid inlet pipe is connected to the connecting joint and the pumping mechanism so as to enable the liquid storage reservoir to be in communication with the pumping mechanism.

6. The handle of the air fryer configured to be connected to the pot body of the air fryer according to claim 5, wherein:
the connecting joint comprises a liquid inlet column extending upward for a certain distance,
the liquid outlet is disposed with a sealing sleeve configured for elastic deformation, and
the liquid inlet column is configured to be inserted into the sealing sleeve to achieve a hermetical connection.

7. The handle of the air fryer configured to be connected to the pot body of the air fryer according to claim 1, wherein:
the spraying device further comprises a liquid inlet pipe, and
when the liquid storage reservoir is connected to the handle body:
the liquid inlet pipe is inserted into the liquid storage reservoir from top to bottom, and
the liquid inlet pipe is connected to the pumping mechanism to enable the liquid storage reservoir to be in communication with the pumping mechanism.

8. The handle of the air fryer configured to be connected to the pot body of the air fryer according to claim 7, wherein:
the handle body comprises a first connecting portion,
an upper end of the liquid storage reservoir comprises a second connecting portion, and
when the liquid inlet pipe is inserted into the liquid storage reservoir from the top to the bottom, the second connecting portion is detachably connected to the first connecting portion.

9. The handle of the air fryer configured to be connected to the pot body of the air fryer according to claim 5, wherein:
the pumping mechanism comprises a pumping chamber, a piston rod, and an elastic member,
the pumping chamber comprises a liquid inlet port and a liquid outlet port,
the liquid inlet port is disposed with a check valve,
the elastic member abuts the piston rod and a chamber wall of the pumping chamber,
the liquid inlet port is connected to the liquid inlet pipe,
the liquid outlet port is connected to the spray head,
a distal end of the piston rod extends out of the pumping chamber to define or be connected to a button for controlling liquid discharge,
the button is configured to be controlled by an external force to drive the piston rod to pump the liquid in the pumping chamber to the spray head, and
the elastic member is configured to drive the piston rod to move to an original position to suck the liquid in the liquid inlet pipe into the pumping chamber through the check valve.

10. The handle of the air fryer configured to be connected to the pot body of the air fryer according to claim 7, wherein:
the pumping mechanism comprises a pumping chamber, a piston rod, and an elastic member,
the pumping chamber comprises a liquid inlet port and a liquid outlet port,
the liquid inlet port is disposed with a check valve,
the elastic member abuts the piston rod and a chamber wall of the pumping chamber,
the liquid inlet port is connected to the liquid inlet pipe,
the liquid outlet port is connected to the spray head,
a distal end of the piston rod extends out of the pumping chamber to define or be connected to a button for controlling liquid discharge,
the button is configured to be controlled by an external force to drive the piston rod to pump the liquid in the pumping chamber to the spray head, and
the elastic member is configured to drive the piston rod to move to an original position to suck the liquid in the liquid inlet pipe into the pumping chamber through the check valve.

11. An air fryer, comprising the handle according to claim 1.

12. The air fryer according to claim 11, wherein:
the pumping mechanism comprises a button for controlling liquid discharge, and
the button is disposed on the handle body.

13. The air fryer according to claim 11, wherein:
the spray head is a mist-spraying head.

14. The air fryer according to claim 11, wherein:
the liquid spraying direction of the spray head extends obliquely from an edge of the pot body toward a middle portion of a bottom of the pot body.

15. The air fryer according to claim 11, wherein:
the spraying device further comprises a connecting joint and a liquid inlet pipe which are disposed in the handle body,
the liquid storage reservoir comprises a liquid outlet located on a bottom of the liquid storage reservoir,
the liquid outlet of the liquid storage reservoir is configured to be detachably and hermetically connected to the connecting joint, and
the liquid inlet pipe is connected to the connecting joint and the pumping mechanism so as to enable the liquid storage reservoir to be in communication with the pumping mechanism.

16. The air fryer according to claim 15, wherein:
the connecting joint comprises a liquid inlet column extending upward for a certain distance,
the liquid outlet is disposed with a sealing sleeve configured for elastic deformation, and
the liquid inlet column is configured to be inserted into the sealing sleeve to achieve a hermetical connection.

17. The air fryer according to claim 11, wherein:
the spraying device further comprises a liquid inlet pipe, and
when the liquid storage reservoir is connected to the handle body:
the liquid inlet pipe is inserted into the liquid storage reservoir from top to bottom, and
the liquid inlet pipe is connected to the pumping mechanism to enable the liquid storage reservoir to be in communication with the pumping mechanism.

18. The air fryer according to claim 17, wherein:
the handle body comprises a first connecting portion,
an upper end of the liquid storage reservoir comprises a second connecting portion, and
when the liquid inlet pipe is inserted into the liquid storage reservoir from the top to the bottom, the second connecting portion is detachably connected to the first connecting portion.

19. The air fryer according to claim 15, wherein:
the pumping mechanism comprises a pumping chamber, a piston rod, and an elastic member,
the pumping chamber comprises a liquid inlet port and a liquid outlet port,
the liquid inlet port is disposed with a check valve,
the elastic member abuts the piston rod and a chamber wall of the pumping chamber,
the liquid inlet port is connected to the liquid inlet pipe,
the liquid outlet port is connected to the spray head,
a distal end of the piston rod extends out of the pumping chamber to define or be connected to a button for controlling liquid discharge,
the button is configured to be controlled by an external force to drive the piston rod to pump the liquid in the pumping chamber to the spray head, and
the elastic member is configured to drive the piston rod to move to an original position to suck the liquid in the liquid inlet pipe into the pumping chamber through the check valve.

20. The air fryer according to claim 17, wherein:
the pumping mechanism comprises a pumping chamber, a piston rod, and an elastic member,
the pumping chamber comprises a liquid inlet port and a liquid outlet port,
the liquid inlet port is disposed with a check valve,
the elastic member abuts the piston rod and a chamber wall of the pumping chamber,
the liquid inlet port is connected to the liquid inlet pipe,
the liquid outlet port is connected to the spray head,
a distal end of the piston rod extends out of the pumping chamber to define or be connected to a button for controlling liquid discharge,
the button is configured to be controlled by an external force to drive the piston rod to pump the liquid in the pumping chamber to the spray head, and
the elastic member is configured to drive the piston rod to move to an original position to suck the liquid in the liquid inlet pipe into the pumping chamber through the check valve.
